(19) United States
(12) Patent Application Publication
(10) Pub. No.: US 2024/0370787 A1
(43) Pub. Date: Nov. 7, 2024

(54) METHOD AND APPARATUS FOR CALCULATING CARBON INTENSITIES, TERMINAL AND STORAGE MEDIUM

(71) Applicants: ENVISION DIGITAL INTERNATIONAL PTE. LTD., Singapore (SG); SHANGHAI ENVISION DIGITAL CO., LTD., Shanghai (CN)

(72) Inventors: Guangyi LIU, Shanghai (CN); Zhihong LI, Shanghai (CN); Yachen TANG, Shanghai (CN); Tingting LIU, Shanghai (CN); Jun TAN, Shanghai (CN); Hong FAN, Shanghai (CN); Yu ZHANG, Shanghai (CN); Haiming FU, Shanghai (CN)

(73) Assignees: ENVISION DIGITAL INTERNATIONAL PTE. LTD., Singpore (SG); SHANGHAI ENVISION DIGITAL CO., LTD., Shanghai (CN)

(21) Appl. No.: 18/691,016

(22) PCT Filed: Sep. 9, 2022
(86) PCT No.: PCT/SG2022/050645

§ 371 Date: Mar. 11, 2024

(30) Foreign Application Priority Data
Sep. 10, 2021 (CN) 202111062526.9

(51) Int. Cl. G06Q 10/063; G06F 17/10; G06Q 50/06

(52) U.S. Cl. CPC G06Q 10/063; G06F 17/10; G06Q 50/06

(57) ABSTRACT

The embodiments of the present application disclose a method and apparatus for calculating carbon emission intensities, and a terminal and a storage medium thereof, which belong to the field of energy management. The method includes: acquiring basic attribute data of a power system, and acquiring an active power generation amount of a power generator set based on the basic attribute data; acquiring an initial value of a carbon emission factor of power generation fuel of the power generator set according to a life cycle type of the power generator set, wherein the initial value is defined to indicate a carbon emission amount caused by a unit power generation amount; and acquiring a carbon intensity of the power generator set based on the active power generation amount and the initial weight value of the power generator set. According to the embodiments of the application, the carbon intensity of the power generator set may be determined in real time based on the active power generation amount and the initial value of the carbon emission factor of power generation fuel of the power generator set, such that statistical collection of the carbon emission amounts of the power generator sets in the power plant is achieved in real time, and the statistical granularity of the carbon intensity is reduced, thereby improving the monitoring effect of the carbon intensity of the power generator set.

### TECHNICAL FIELD

Embodiments of the present disclosure relate to the field of energy management, and in particular to a method and an apparatus for calculating carbon intensities, and a terminal and a storage medium thereof.

### BACKGROUND

As global warming is becoming prominent, carbon emissions are in control in various fields. In the field of energy, a carbon intensity generated by power generation is increasingly prioritized by local administrative departments as an important measurement indicator for assessment of an industrial production process.

In related arts, the administrative department may acquire a total net power generation amount, fuel types and a total fuel consumption amount of all power plants in the managed region in a statistical cycle of one quarter or one year, calculate and publish a marginal emission factor of electricity, also known as the carbon intensity.

### SUMMARY

Embodiments of the present disclosure provide a method and an apparatus for calculating carbon intensities, and a terminal and a storage medium thereof.

According to one aspect of the present disclosure, a method for calculating carbon intensities is provided. The method includes:
acquiring basic attribute data of a power system, and acquiring an active power generation amount of a power generator set based on the basic attribute data;
acquiring an initial value of a carbon emission factor of power generation fuel of the power generator set according to a life cycle type of the power generator set, wherein the initial value of the carbon emission factor of power generation fuel is defined to indicate a carbon emission caused by a unit power generation amount; and
calculating a carbon intensity of the power generator set based on the active power generation amount and the initial value of the carbon emission factor of power generation fuel of the power generator set.

According to another aspect of the present disclosure, an apparatus for calculating carbon intensities is provided. The apparatus includes:
a first acquiring module, configured to acquire basic attribute data of a power system, and acquire an active power generation amount of a power generator set based on the basic attribute data;
a second acquiring module configured to acquire an initial value of a carbon emission factor of power generation fuel of the power generator set according to a life cycle type of the power generator set, wherein the initial value of the carbon emission factor of power generation fuel is defined to indicate a carbon emission caused by a unit power generation amount; and
a data calculating module, configured to calculate a carbon intensity of the power generator set based on the active power generation amount and the initial value of the carbon emission factor of power generation fuel of the power generator set.

According to another aspect of the present disclosure, a terminal is provided. The terminal includes: a processor and a memory, the memory storing one or more instructions thereon, wherein the processor, when loading and executing the one or more instructions, is caused to perform the method for calculating the carbon intensities according to various aspects of the present disclosure.

According to another aspect of the present disclosure, a non-transitory computer-readable storage medium storing one or more instructions thereon is provided, wherein the one or more instructions, when loaded and executed by a processor of a terminal, cause the terminal to perform the method for calculating the carbon intensities according to various aspects of the present disclosure.

According to one aspect of the present disclosure, a computer program product including one or more computer instructions is provided, wherein the one or more computer instructions are stored in a non-transitory computer-readable storage medium. The one or more computer instructions, when loaded and executed by a processor of a computer device, cause the computer device to perform the method for calculating the carbon intensities according to various aspects of the present disclosure.

The technical solutions according to the embodiments of the present disclosure achieve the following beneficial effects:

The basic attribute data of the power system is acquired, and the active power generation amount of the power generator set is acquired based on the basic attribute data; then the initial value of the carbon emission factor of power generation fuel of the power generator set is acquired according to the life cycle type of the power generator set, wherein the initial value of the carbon emission factor of power generation fuel is defined to indicate the carbon emission amount caused by the unit power generation amount; and finally, the carbon intensity of the power generator set is calculated based on the active power generation amount and the initial value of the carbon emission factor of power generation fuel of the power generator set. Since the carbon intensity of the power generator set is calculated based on the active power generation amount of the power generator set and the initial value of the carbon emission factor of power generation fuel of the power generator set, the carbon intensity of the smallest unit of the power generator set in a power generation system may be monitored, such that monitoring granularity of the carbon intensity in the entire power system is reduced, and statistical collection of the real-time carbon intensity of each power plant or region is achieved by accumulating those of different power generator sets, which provides relevant data for subsequent carbon trading in the power system, thereby promoting development of energy saving and emission reduction.

### BRIEF DESCRIPTION OF THE DRAWINGS

In order to more clearly illustrate the technical solutions in the embodiments of the present disclosure, the drawings required to be used in the description of the embodiments of the present disclosure are briefly introduced below. It is obvious that the drawings in the description below are only some embodiments of the present disclosure, and it is obvious for those skilled in the art that other drawings may be derived according to the drawings without creative efforts.

FIG. 1 is a structural block diagram of a terminal according to an exemplary embodiment of the present disclosure;

FIG. 2 is a block diagram of a system for calculating carbon intensities according to an exemplary embodiment of the present disclosure;

FIG. 3 is a block diagram of a system for calculating carbon intensities according to an exemplary embodiment of the present disclosure;

FIG. 4 is a flowchart of a method for calculating carbon intensities according to an exemplary embodiment of the present disclosure;

FIG. 5 is a flowchart of a method for calculating carbon intensities according to another exemplary embodiment of the present disclosure;

FIG. 6 is a schematic diagram of carbon intensity monitoring according to the present disclosure based on the embodiment shown in FIG. 5;

FIG. 7 is a flowchart of a method for tracking carbon footprints in a region according to an exemplary embodiment of the present disclosure;

FIG. 8 is a flowchart of a method for calculating carbon intensities according to an exemplary embodiment of the present disclosure;

FIG. 9 is a flowchart of a method for calculating carbon intensities by region according to an exemplary embodiment of the present disclosure; and

FIG. 10 is a structural block diagram of an apparatus for calculating carbon intensities according to an exemplary embodiment of the present disclosure.

### DETAILED DESCRIPTION

For clearer descriptions of the objects, technical solutions, and advantages of the present disclosure, the embodiments of the present disclosure are further described in detail below with reference to the accompanying drawings.

When the following description refers to the accompanying drawings, the same numbers in different drawings represent the same or similar elements unless otherwise indicated. The implementations described in the following exemplary embodiments do not represent all implementations consistent with the present disclosure. Rather, the implementations are merely examples of apparatus and methods consistent with certain aspects of the present disclosure, as detailed in the appended claims.

In the description of the present disclosure, it should be understood that the terms “first,” “second,” or the like are merely used for descriptive purposes only and should not be construed as indicating or implying the relative importance. In the description of the present disclosure, it should be noted that, unless otherwise explicitly specified and defined, the terms “connecting” and “connection” shall be understood in a broad sense, for example, a fixed connection, a detachable connection or an integral connection, or a mechanical connection or an electrical connection, or a direct connection or an indirect connection via an intermediate medium. For those of ordinary skill in the art, the specific meanings of the above terms in the present disclosure may be understood according to the specific conditions. In addition, in the description of the present disclosure, “a plurality of” means two or more unless otherwise stated. The term “and/or” describes the association relationship of the associated objects, and indicates that there may be three relationships. For example, A and/or B may indicate that: only A is present, both A and B are present, and only B is present. The symbol “/” usually indicates an “or” relationship between the associated objects.

As used herein, the term “if” is optionally interpreted as “when,” “in response to determining that,” or “in response to a detecting that,” depending on the context. Similarly, the phrase “in the case that it is determined that . . . ” or “in the case that it is detected that (stated condition or event)” or “in response to detecting that (stated condition or event)” depending on the context.

It should be noted that use of personally identifiable information shall comply with privacy policies and practices recognized as meeting or exceeding industry or government requirements for protecting user's privacy. Specifically, the personally identifiable information should be explicitly explained to the user the nature of authorized use during management and processing to minimize the risk of inadvertent or unauthorized access or use.

For ease of understanding the solutions shown in the embodiments of the present disclosure, several terms present in the embodiments of the present disclosure are described below.
GDF: Grid data fabric
CI: Carbon intensity
Multi-time scales
Multi-spatial dimensions

For example, a method for calculating carbon intensities shown in the embodiments of the present disclosure may be applied in a terminal having a display screen and having a function of calculating carbon intensity. The terminal may include a laptop, a desktop, an all-in-one computer, a server, or a workstation. It should be noted that when the amount of data calculation required by the present disclosure increases, a high-performance terminal is required. Those of skills in applying the present disclosure may schematically adjust hardware performance of the terminal running the solutions of the present disclosure.

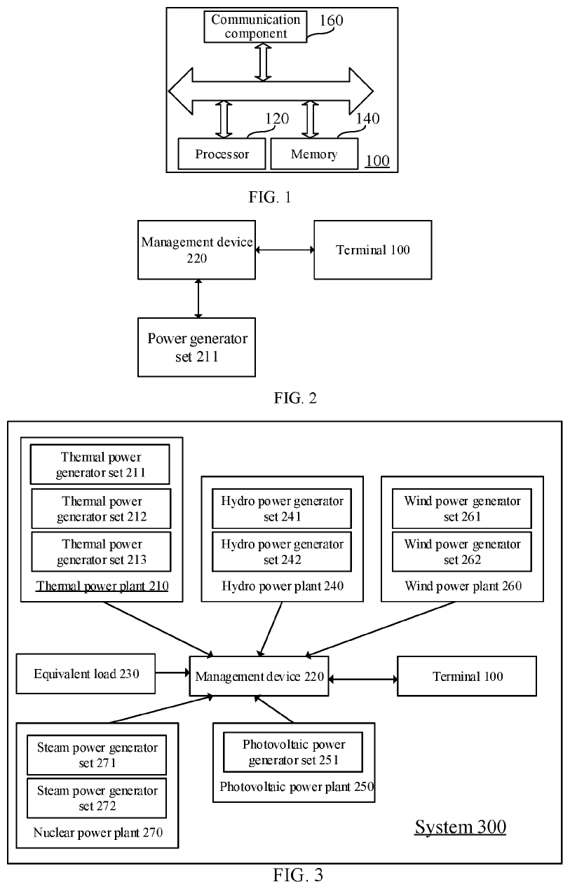

Now referring to FIG. 1, FIG. 1 is a structural block diagram of a terminal according to an exemplary embodiment of the present disclosure. As shown in FIG. 1, the terminal includes a processor 120, a memory 140, and a communication component 160. The memory 140 stores one or more instructions thereon, wherein the processor 120, when loading and executing the one or more instructions, is cause to perform the method for calculating the carbon intensities according to the method embodiments of the present disclosure. The communication component 160 is configured to receive data acquired from the outside and send out the data.

In the present disclosure, the terminal 100 may acquire the basic attribute data of the power system, and acquire the active power generation amount of the power generator set based on the basic attribute data; acquire the initial value of the carbon emission factor of power generation fuel of the power generator set according to the life cycle type of the power generator set, wherein the initial value of the carbon emission factor of power generation fuel is defined to indicate the carbon emission amount caused by the unit power generation amount; and calculate the carbon intensity of the power generator set based on the active power generation amount and the initial value of the carbon emission factor of power generation fuel of the power generator set.

The processor 120 may include one or more processing cores. The processor 120 connects various parts within the entire terminal 100 using various interfaces and lines, executes various functions of the terminal 100 and processes data by loading or executing instructions, programs, code sets or instruction sets stored in the memory 140, and calling data stored in the memory 140. Optionally, the processor 120 may be achieved in at least one hardware form of a digital signal processing (DSP), a field-programmable gate array (FPGA), and a programmable logic array (PLA). The processor 120 may integrate one or more combinations of a central processing unit (CPU), a graphics processing unit (GPU), a modem, or the like. The CPU mainly processes an operating system, a user interface, an application program, or the like; the GPU is configured to render and draw the content required to be displayed by the display screen; and the modem is configured to process a wireless communication. It may be appreciated that the modem described above may not be integrated into the processor 120, but is achieved by a single chip.

The memory 140 may include a random-access memory (RAM) or a read-only memory (ROM). Optionally, the memory 140 includes a non-transitory computer-readable storage medium. The memory 140 may be configured to store instructions, programs, codes, code sets or instruction sets. The memory 140 may include a program storage partition and a data storage partition, wherein the program storage partition may store instructions for implementing an operating system, instructions for at least one function (for example, a touch function, a sound playing function, an image playing function, or the like), instructions for implementing the following various method embodiments, or the like; and the data storage partition may store data involved in the following method embodiments.

The communication component 160 may include a signal processing module and an antenna. The antenna may also be replaced by a communication cable. For example, the terminal 100 in the present disclosure may acquire the basic attribute data of the power system, and the data may be acquired from an external power system. The basic attribute data may be stored in a specified device, and upon acquiring the corresponding authorization. the terminal 100 may acquire the basic attribute data via the communication component 160.

Now referring to FIG. 2, FIG. 2 is a block diagram of a system for calculating carbon intensity according to an exemplary embodiment of the present disclosure. The system 200 includes a terminal 100, a power generator set 211, and a management device 220. The power generator set 211 is connected to the management device 220. The management device 220 stores an active power generation amount of devices including the power generator set 211. It should be noted that data stored in the management device 220 may not be the active power generation amount, but a set of other intermediate data, and the intermediate data is calculated to acquire the active power generation amount of the power generator set 211.

It should be noted that the terminal 100 may be placed in a dispatching center or a monitoring center. The terminal 100 may display the data over a plurality of screens. For example, when a terminal in the dispatching center runs the solution, the dispatching center may display the carbon intensity of the currently managed power generator set or power plant in real time over a plurality of display screens.

Now referring to FIG. 3, FIG. 3 is a block diagram of a system for calculating carbon intensities according to an exemplary embodiment of the present disclosure. The system 300 includes a terminal 100, a thermal power plant 210, a management device 220, an equivalent load 230, a hydro power plant 240, a photovoltaic power plant 250, a wind power plant 260, and a nuclear power plant 270.

Each power plant has its own power generator set. In one possible scenario, the power generator sets belonging to the same power plant are of the same type. For example, the power generator sets belonging to the thermal power plant 210 are all thermal power generator sets. In another possible scenario, the power generator sets belonging to the same power plant may be of different types. For example, a hybrid power plant includes a photovoltaic power generator set and a thermal power generator set. The embodiments of the present disclosure do not limit the types of the power generator sets in a power plant. Whether the types of the power generator sets in the same power plant are the same or not, the solutions shown in the present disclosure may be used.

The following introduces the case of the power generator sets in the each power plant in the example.

For a thermal power plant 210, a thermal power generator set 211, a thermal power generator set 212, and a thermal power generator set 213 are provided.

For a hydro power plant 240, a hydro power generator set 241 and a hydro power generator set 242 are provided.

For a photovoltaic power plant 250, a photovoltaic power generator set 251 is provided.

For a wind power plant 260, a wind power generator set 261 and a wind power generator set 262 are provided.

For a nuclear power plant 270, a steam power generator set 271 and a steam power generator set 272 are provided.

In this example, data for each power plant may be acquired by the management device 220. In one possible implementation, each power plant has a dedicated device for managing the power generator sets of the plant. The management device 220 communicates with the dedicated devices of the power plants to acquire data of the power generator sets of the power plants. For example, the management device may communicate with the dedicated devices of the power plants to acquire the active power generation amounts of the power generator sets of the power plants. In another possible implementation, the management device 220 directly communicates with the power generator sets in the power plant to acquire relevant data of each power generator set.

The equivalent load 230 may be a device that consumes power caused by other devices in a power grid where the system 300 is located during a first time period, and provides power to the power grid where the system 300 is located during a second time period. It should be noted that the first time period and the second time period are two time periods that do not overlap.

In other words, the equivalent load 230 may be an equivalent object of a port outside the system 300.

With the proposal of carbon peaking and carbon neutrality initiatives, the carbon trading market is actually the tradable carbon emission performance standard for various industries. The power industry, as a main battlefield for achieve carbon peaking and carbon neutrality goals, proposes to build a new power system with new energy as a major component. The low-carbon transition of power industry becomes an important demand and key focus of government institutions. A quantitative analysis of carbon intensity serves as a basic technical support, such that more accurate energy flow and optimized operation of the power grid are achieved via carbon footprint management by time and region, thereby minimizing the strong random fluctuation of new energies and improving the utilization rate of new energies.

Many factors may affect the carbon intensity, and different conclusions may be drawn according to different concerns. Among the factors, economic scale, energy intensity, energy structure and industrial structure are some factors frequently present in the current research field. Before the solutions shown in the present disclosure, an administrative department summarizes the regions composed of a plurality of provinces and regions, thereby acquiring the carbon intensity of a specified region in a specified measurement period.

Based on the above problem. for government institutions, the solutions provided by the present disclosure may be used for monitoring the total amount of carbon emission in an administrative region under jurisdiction and performing carbon index distribution. For the power department, the solutions according to the present disclosure may interpret carbon footprints of electric energy, and assist the promotion of new energy consumption and power market reform.

In other solutions provided by the present disclosure, since the source of the electric energy used by a common enterprise may be monitored, the power generator set may be finally traced. Therefore, the carbon intensity of the common enterprise during power consumption may also be monitored, which improves the control of carbon intensity in the common enterprise during manufacturing. For the enterprise with export needs, the present disclosure may provide precise marketing based on the carbon intensity during manufacturing, assist the schedules and participation in the carbon trading of the enterprises.

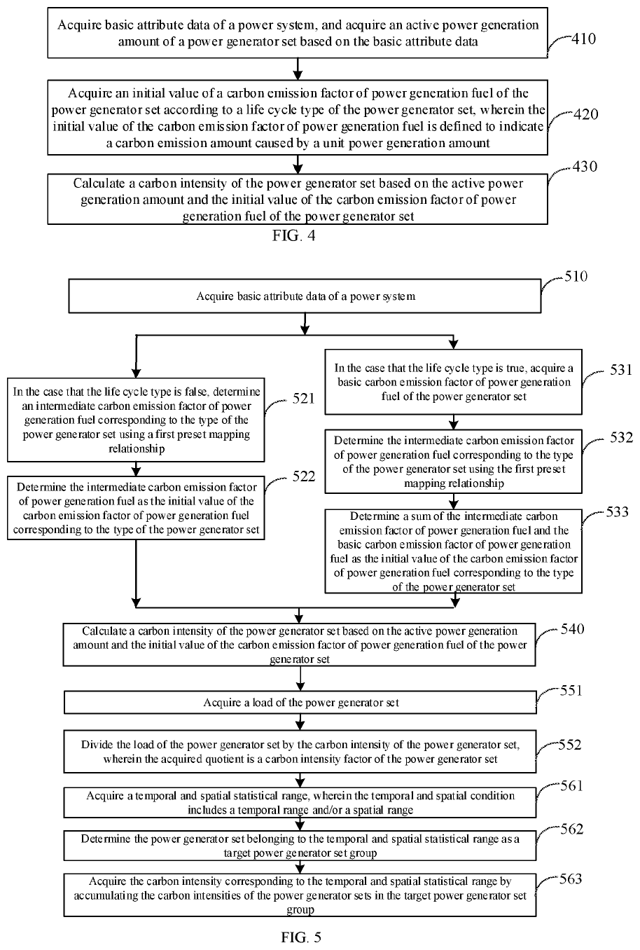

Now referring to FIG. 4, FIG. 4 is a flowchart of a method for calculating carbon intensities according to an exemplary embodiment of the present disclosure. The method for calculating the carbon intensities is applicable the terminal described above. In FIG. 4, the method for calculating the carbon intensities includes the following steps.

In step 410, basic attribute data of a power system is acquired, and an active power generation amount of a power generator set is acquired based on the basic attribute data.

In the embodiments of the present disclosure, the terminal may acquire the basic attribute data of the power system. It should be noted that in one possible implementation, the basic attribute data may directly include the active power generation amount of the power generator set.

In another possible implementation, the basic attribute data includes data for calculating the active power generation amount of the power generator set. For example, the basic attribute data further includes measurement data such as current and voltage of the power generator set, and the active power generation amount of the power generator set is calculated based on the current and the voltage.

Optionally, the basic attribute data may further include at least one of management data, power grid model data, power grid operation data, power supply operation data, load operation data, and transaction data according to data type.

Optionally, the management data may include administrative region data, type of power generator set, and installation capacity of power generator set. Illustratively, the administrative region data may be data of a province, a city, a district, a county and a town. The type of the power generator set includes thermal power generator set, hydro power generator set, wind power generator set, photovoltaic power generator set and nuclear power generator set. The input power of the thermal power generator set is thermal energy; the input power of the hydro power generator set is hydro potential energy; the input power of the wind power generator set is wind kinetic energy; the input power of the photovoltaic power generator set is solar energy; and the input power of the nuclear power generator set is nuclear energy. The installation capacity of the power generator set is defined to indicate a maximum power generation capacity of a single power generator set.

Optionally, the power grid operation data includes measurement data such as an active power generation amount, a reactive power generation amount, a current of the power generator set and a voltage of the power generator set.

Optionally, the power supply operation data includes energy power prediction data, power generation plan data and maintenance plan data.

Optionally, the load operation data includes bus load prediction data, energy storage, electric vehicle charging and discharging power and ordered power consumption sequence.

Optionally, the transaction data includes a med-and long-term transaction curve of a power plant and a day-ahead planning curve of a power plant.

In step 420, an initial value of a carbon emission factor of power generation fuel of the power generator set is acquired according to a life cycle type of the power generator set, wherein the initial value of the carbon emission factor of power generation fuel is defined to indicate a carbon emission amount caused by a unit power generation amount.

In this example, the terminal may acquire the initial value of the carbon emission factor of power generation fuel of the power generator set according to the life cycle type of the power generator set.

Optionally, the life cycle type includes true and false. A true life cycle type indicates that the life cycle type of the power generator set should be considered when determining the initial value of the carbon emission factor of power generation fuel of the power generator set. A false life cycle type indicates that the life cycle type of the power generator set is not necessarily considered when determining the initial value of the carbon emission factor of power generation fuel of the power generator set.

In this example, different life cycle types correspond to different mapping relationships. In the case that the life cycle type of the power generator set is determined, the terminal may acquire the initial value of the carbon emission factor of power generation fuel of the power generator set, and the initial value of the carbon emission factor of power generation fuel may be defined to indicate a carbon emission amount caused by a unit power generation amount. It should be noted that the initial value of the carbon emission factor of power generation fuel may be a coefficient without a unit, and a higher coefficient indicates a higher amount of carbon generated by the power generator set when generating the unit power generation amount. Accordingly, a lower initial value of the carbon emission factor of power generation fuel of the power generator set indicates a lower amount of carbon generated by the power generator set when generating the unit power generation amount.

In step 430, the carbon intensity of the power generator set is calculated based on the active power generation amount and the initial value of the carbon emission factor of power generation fuel of the power generator set.

In the embodiments of the present disclosure, the terminal may multiply the active power generation amount by the initial value of the carbon emission factor of power generation fuel of the power generator set, and use the product as the carbon intensity of the power generator set. Therefore, in the embodiments of the present disclosure, basic carbon intensity of the power generator set may be acquired.

Optionally, in the case that data of the power generator set is updated in real time, the carbon intensity demonstrated by the terminal is also real-time updated data.

Optionally, in the case that a display screen of the terminal may display the carbon intensity of the power generator set, when the carbon intensity is real-time updated data of the power generator set, the terminal may display the current carbon intensity of the power generator set in real time.

Illustratively, in the case that the active power generation amount P of the power generator set is known, the initial value of the carbon emission factor of power generation fuel of the power generator set is coef, and the carbon intensity CI of the power generator set may be acquired by multiplying the two. CI=P*coef.

On this basis, in the case that the carbon intensity CI of the power plant needs to be calculated, N power generator sets may be included in the power plant, and the carbon intensity of each power generator set is CI1, CI2, . . . and CIn. The present disclosure accumulates the carbon intensity of the power generator sets to acquire the carbon intensity CI of the power plant. The relevant formula may be CI−plant(i)=CI1+CI2+ . . . +CIn.

In summary, in the method for calculating the carbon intensities according to the embodiments, the basic attribute data of the power system is acquired, and the active power generation amount of the power generator set is acquired based on the basic attribute data; then the initial value of the carbon emission factor of power generation fuel of the power generator set is acquired according to the life cycle type of the power generator set, wherein the initial value of the carbon emission factor of power generation fuel is defined to indicate the carbon emission amount caused by the unit power generation amount; and finally, the carbon intensity of the power generator set is calculated based on the active power generation amount and the initial value of the carbon emission factor of power generation fuel of the power generator set. Since present disclosure may calculate the carbon intensity of the power generator set based on the active power generation amount of the power generator set and the initial value of the carbon emission factor of power generation fuel of the power generator set, the carbon intensity of the smallest unit of the power generator set in a power generation system may be monitored, such that monitoring granularity of the carbon intensity in the entire power system is reduced, and real-time carbon intensity of each power plant or region may also be calculated by accumulating those of different power generator sets, which provides relevant data for subsequent carbon trading in the power system, thereby promoting development of energy saving and emission reduction.

Based on the solution disclosed in the previous embodiment, the terminal may also perform the method for calculating the carbon intensities in another possible implementation, and reference may be made to the following embodiments.

Now referring to FIG. 5, FIG. 5 is a flowchart of a method for calculating carbon intensities according to another exemplary embodiment of the present disclosure. The method for calculating the carbon intensities is applicable to the terminal described above. In FIG. 5, the method for calculating the carbon intensities includes the following steps.

In step 510, basic attribute data of a power system is acquired.

In the embodiments of the present disclosure, the execution process of step 510 is the same as the execution process of step 410, which is thus not repeated herein.

Upon completion of step 510, step 521 and step 522 may be performed, and step 531, step 532, and step 533 may be performed.

In step 521, in the case that the life cycle type is false, an intermediate carbon emission factor of power generation fuel corresponding to the type of the power generator set is determined according to a first preset mapping relationship.

In this example, the life cycle type of the power generator set is false, which indicates that the initial value of the carbon emission factor of power generation fuel of the power generator set is determined without considering the life cycle of the power generator set. In this scenario, the first preset mapping relationship is preset in the terminal. The terminal may determine the intermediate carbon emission factor of power generation fuel corresponding to the type of the power generator set according to the type of the power generator set recorded in the first preset mapping relationship.

In step 522, the intermediate carbon emission factor of power generation fuel is determined as the initial value of the carbon emission factor of power generation fuel corresponding to the type of the power generator set.

In this example, the terminal may directly determine the intermediate carbon emission factor of power generation fuel as the initial value of the carbon emission factor of power generation fuel, because a full life cycle of the power generator set is not considered.

For example, when the terminal does not consider the full life cycle of the power generator set, the first preset mapping relationship may be as shown in Table I.

TABLE I

| | | | | | Biomass | |
|---|---|---|---|---|---|---|
| | | Photovoltaic | | | power | Thermal |
| Type of power | Hydro power | power | Wind power | Nuclear power | generator | power |
| generator set | generator set | generator set | generator set | generator set | set | generator set |
| Intermediate | 1 | 1 | 1 | 5 | 20 | x, x belongs |
| carbon | | | | | | to [80, 90] |
| emission factor | | | | | | |
| of power | | | | | | |
| generation fuel | | | | | | |
| Initial value of | 1 | 1 | 1 | 5 | 20 | x, x belongs |
| carbon | | | | | | to [80, 90] |
| emission factor | | | | | | |
| of power | | | | | | |
| generation fuel | | | | | | |

It should be noted that a process shown in Table I may be summarized as follows: the terminal acquires the type of the power generator set, wherein the type of the power generator set is defined to indicate the input power adopted by the power generator set, and the input power includes at least one of thermal energy, hydro potential energy, wind kinetic energy, solar energy and nuclear energy. The terminal may determine the intermediate carbon emission factor of power generation fuel corresponding to the type of the power generator set according to the record of the first preset mapping relationship.

In this scenario, the terminal may directly determine the intermediate carbon emission factor of power generation fuel determined according to the type of the power generator set as the initial value of the carbon emission factor of power generation fuel. Illustratively, the carbon emission factor of power generation fuel may be recorded as coef.

In the case that fuel conditions of the thermal power generator set are different, conditions of the intermediate carbon emission factor of power generation fuel are also different. In the embodiments of the present disclosure, in the case that the input energy adopted by the power generator set includes thermal energy, that is, in the case that the power generator set is a thermal power generator set, a set of the intermediate carbon emission factors of power generation fuel corresponding to the thermal power generator set is determined according to the record of the first preset mapping relationship, wherein the set of the intermediate carbon emission factors of power generation fuel is a set including n integers, n being a positive integer; a thermal power carbon emission rating in the power system to which the thermal power generator set belongs is acquired, wherein the thermal power carbon emission rating is defined to indicate the carbon emission when the thermal power generator set generates a unit power; and the intermediate carbon emission factor of power generation fuel corresponding to the thermal power carbon emission rating is determined from the set of the intermediate carbon emission factors of power generation fuel according to a second preset mapping relationship, wherein the second preset mapping relationship is associated with the power system to which the thermal power generator set belongs.

In a specific embodiment, in the case that the type of the power generator set is a thermal power generator set, the present disclosure determines the intermediate carbon emission factor of power generation fuel as an integer x, with x belonging to [80, 90]. Then, the present disclosure may acquire a thermal power level of an administrative region where the thermal power generator set is located, and determine the specific value of X according to the thermal power level and a subdivided thermal power mode of the thermal power generator set.

For example, the thermal power generator set belongs to an administrative region A, and the thermal power level of the administrative region A is divided into four levels Q1, Q2, Q3 and Q4. The Q1 level represents a conventional coal-fired power generator set of 300 MW or greater; the Q2 level represents a conventional coal-fired power generator set of 300 MW level or less; the Q3 level represents an unconventional coal-fired power generator set; and the Q4 level represents a gas-powered power generator set.

On this basis, in the present disclosure, the Q1 level corresponds to an intermediate carbon emission factor of power generation fuel 90, the Q2 level corresponds to an intermediate carbon emission factor of power generation fuel 87, the Q3 level corresponds to an intermediate carbon emission factor of power generation fuel 83, and the Q4 level corresponds to an intermediate carbon emission factor of power generation fuel 80.

It should be noted that the above solution is only an example to illustrate a determination method of the intermediate carbon emission factor of power generation fuel in the case that the thermal power of the administrative region is divided into 4 levels. According to different administrative regions, the solutions according to the present disclosure may adapt to administrative regions with up to 11 thermal power levels to determine the intermediate carbon emission factor of power generation fuel. In the case that the number of thermal power levels exceeds 11, in the solution, the intermediate carbon emission factor of power generation fuel may be determined by plurality of thermal power levels corresponding to one intermediate carbon emission factor of power generation fuel. For example, in the case that the number of thermal power levels is 22, 2 thermal power levels may correspond to one intermediate carbon emission factor of power generation fuel. For example, the thermal power level q1 and the thermal power level q2 correspond to the intermediate carbon emission factor of power generation fuel 90.

In step 531, in the case that the life cycle type is true, a basic carbon emission factor of power generation fuel of the power generator set is acquired.

The basic carbon emission factor of power generation fuel is defined to indicate an estimate of a carbon emission amount generated by the power generator set before operation in generating power.

Optionally, in the case that the present disclosure considers a full life cycle of the power generator set including the carbon intensity generated by the power generator set during production, transportation, or the like, it is necessary to input the basic carbon emission factor of power generation fuel that includes planning data and device manufacturers. Optionally, the terminal may read the carbon intensity generated by the power generator set during manufacturing from a device factor library. Then, the terminal determines the carbon intensity generated during a transportation process according to the transportation mode of the power generator set and the transportation distance. The transportation distance is a distance from the manufacturer of the power generator set to the deployment site.

In step 532, the intermediate carbon emission factor of power generation fuel corresponding to the type of the power generator set is determined using the first preset mapping relationship.

It should be noted that step 532 is similar to step 521, which is thus not repeated herein.

In step 533, a sum of the intermediate carbon emission factor of power generation fuel and the basic carbon emission factor of power generation fuel is determined as the initial value of the carbon emission factor of power generation fuel corresponding to the type of the power generator set.

In this example, the intermediate carbon emission factor of power generation fuel and the basic carbon emission factor of power generation fuel calculated in the above steps are added to acquire the initial value of the carbon emission factor of power generation fuel corresponding to the type of the power generator set.

For example, in the case that the intermediate carbon emission factor of power generation fuel of the power generator set E1 is F1 and the basic carbon emission factor of power generation fuel of the power generator set E1 is F2, then the initial value of the carbon emission factor of power generation fuel of the power generator set E1 is (F1+F2).

In step 540, the carbon intensity of the power generator set is calculated based on the active power generation amount and the initial value of the carbon emission factor of power generation fuel of the power generator set.

In the present disclosure, step 540 is similar to step 430, which is thus not repeated herein.

In step 551, a load of the power generator set is acquired.

In this example, the terminal may acquire the load of the power generator set.

In one possible implementation, the load of the power generator set may be a real-time load of the power generator set.

In another possible implementation, the load of the power generator set may refer to an average load over a certain period of time.

In step 552, a quotient is acquired by dividing the load of the power generator set by the carbon intensity of the power generator set, wherein the acquired quotient is a carbon intensity factor of the power generator set.

The carbon intensity factor is defined to indicate the carbon emission amount caused by the unit power generation amount of the power generator set, and is positively correlated with the initial value of the carbon emission factor of power generation fuel.

In this example, the terminal may acquire the load of the power generator set and the carbon intensity of the power generator set in the same statistical temporal dimension. For example, a statistical temporal scale may all be real-time statistics, or may all be data in the past time period A.

Upon acquiring the load of the power generator set and the carbon intensity of the power generator set at the same statistical time, the terminal may acquire a quotient by dividing the load of the power generator set by the carbon intensity of the power generator set, wherein the acquired quotient is the carbon intensity factor of the power generator set.

It should be noted that both the carbon intensity factor of the power plant and the carbon intensity factor in the specified region may be calculated by this calculation method, which is not repeated herein.

In step 561, a temporal and spatial statistical range is acquired, wherein the temporal and spatial condition includes a temporal range and/or a spatial range.

In this example, the temporal and spatial statistical range may be acquired in a variety of ways. In one possible implementation, the terminal acquires the range over a user interface (UI). In another possible implementation, the terminal acquires the range via a display screen identification of the currently displayed data.

Optionally, the terminal may select the temporal and spatial statistical range by mouse click, menu click or other means in the UI. In one possible implementation, the temporal and spatial statistical range includes both the temporal range and the spatial range of the statistical data. In another possible implementation, the temporal and spatial statistical range includes only the temporal range, with the spatial range being default data. In still another possible implementation, the temporal and spatial statistical range includes only the spatial range, with the temporal range being the default data.

Optionally, the present disclosure may be integrated into an executable application program. The application program supports an ability to display relevant windows in M display screens at the same time. M may be an integer less than 100. In an initialization phase, the display screen identification may be bound with the temporal and spatial statistical range. For example, a display screen S1 is bound with real-time data of a county A, a display screen S2 is bound with weekly data of the county A, a display screen S3 is bound with real-time data of a county B, and a display screen S4 is bound with real-time data of a power plant E1.

It should be noted that the above binding relationship is only one possible implementation, and does not limit the specific implementation of the present disclosure.

In step 562, the power generator set belonging to the temporal and spatial statistical range is determined as a target power generator set group.

In this example, the terminal may determine the power generator sets participating in power generation as the target power generator set group according to the temporal and spatial statistical range. The target power generator set group includes at least one power generator set.

Optionally, in the case that the terminal determines that no power generator set exists in the target power generator set group, that is, no power generator set participating in the power generation exists in the temporal and spatial statistical range, the terminal ends the calculation process and returns a prompt message. The prompt message may be used for prompting a user to check whether a line is abnormal or not and prompting that no power generator set participates in the power generation in the temporal and spatial statistical range.

Illustratively, in the case that the spatial dimension is included in the temporal and spatial statistical range, a measurement and calculation process of the relevant carbon intensity is as follows.

In one possible application, the spatial dimension may be a nation. a region, a province, a city, a county, a district or a town. Firstly, the terminal may sum loads in the spatial dimension to acquire a sum of load (Sum-Load) in the spatial dimension. Secondly, the terminal may accumulate the carbon intensity of power generator sets in the spatial dimension to acquire the total carbon intensity (SumCI-Plant) of the power generator sets. Subsequently, the terminal measures and calculates the carbon intensity factor in the spatial dimension. In the measurement and calculation process, the terminal divides the total carbon intensity SumCI-Plant of the power generator sets by the sum of load Sum-Load in the spatial dimension to acquire a carbon intensity factor C-factor in the spatial dimension.

Illustratively, in the case that the temporal dimension is included in the temporal and spatial statistical range, the measurement and calculation process of relevant carbon intensity is as follows.

In one possible application, the temporal dimension may be 15 minutes, one hour, one day, ten days, one month, one quarter, or one year. It should be noted that the time period referred to in the above temporal dimension may include only a past time period, or may include both a past time period and a future time period. Data corresponding to the past time period is measured data, and the future time period may refer to data of the same period in the past time period.

For example, in the case that the temporal dimension is 15 minutes or one hour, data corresponding to the future time period may be the data of the same time period in the data of the previous day in the historical data. That is, data of the same time period today may be predicted based on the data in the same time period yesterday.

For another example, in the case that the temporal dimension is one day, data corresponding to the future time period may be the data on the same day in the data of the previous month in the historical data. For example, data on the 18^{th} of this month may be predicted based on the data on the 18^{th} of last month.

In a statistical method based on the year, the present disclosure may acquire carbon emission data in the temporal dimension of every hour. In a year of 365 days, 365*24=8760 pieces of time series data may be acquired. The terminal may connect the 8760 pieces of data according to a temporal sequence to acquire seasonal and peak valley carbon emission data of a statistical object in one year.

Now referring to FIG. 6, FIG. 6 is a schematic diagram of a carbon intensity monitoring according to the present disclosure based on the embodiment shown in FIG. 5. In FIG. 6, a user may select either a statistical region or statistical time. Subsequently, a system may automatically display the carbon intensity in a specified time and region. In FIG. 6, the time is time 1 to time 2, and the region is sub-region A3. The carbon intensity of the region is 47.54, wherein each type of power generation may also be displayed in real time. In addition, an adjustment frame of the carbon emission factor of power generation fuel is provided in FIG. 6, and the user may change the carbon emission factor of power generation fuel according to the needs and then perform statistical collection again.

In step 563, the carbon intensities of the power generator sets in the target power generator set group are accumulated to acquire the carbon intensity corresponding to the temporal and spatial statistical range.

In this example, the terminal may accumulate the carbon intensities of the power generator sets in the target power generator set group, and the carbon intensity acquired after the accumulation is used as the carbon intensity corresponding to the temporal and spatial statistical range.

Optionally, step 536 may be replaced by step (1), step (2) and step (3) to achieve an effect of acquiring the carbon intensity corresponding to the temporal and spatial statistical range.

In step (1), an equivalent load in the temporal and spatial statistical range is acquired.

It should be noted that the equivalent load is defined to indicate an external device powering the target power generator set group. In the power grid corresponding to the specified temporal and spatial statistical range, a port connected to an external power grid is included. The external grid may be a power grid of same level, a lower level, or a higher level. With the instruction of power dispatching, the external power grid may not only acquire power from the power grid corresponding to the temporal and spatial statistical range, but also power the power grid corresponding to the temporal and spatial statistical range.

Based on the above analysis, in the present disclosure, the external power grid outside the power grid corresponding to the temporal and spatial statistical range is uniformly equated as an equivalent load. A value of the equivalent load may be either a positive value or negative value. Thus, the equivalent load may logically represent the external power grid.

Illustratively, in the case that the value of the equivalent load is negative, the equivalent load may be equivalent to a generator.

In step (2), a bus carbon intensity on a power supply path of the equivalent load is acquired, wherein the bus carbon intensity is defined to indicate a sum of the carbon intensity of each line included in the bus and the carbon intensity of a transformer.

In this example, it is necessary to conduct statistical collection on the carbon intensities on a path from the power generator set to the equivalent load within the temporal and spatial statistical range. In one possible implementation, a path of power transmission includes primarily calculation of a line carbon intensity factor and a transformer carbon intensity factor. In other words, the carbon intensity on the path from the power generator set to the equivalent load within the temporal and spatial statistical range is a sum of the line carbon intensity factor and the transformer carbon intensity factor on an optimal power transmission path from the power generator set to the equivalent load within the temporal and spatial statistical range.

Illustratively, the bus carbon intensity may be acquired by topologically fusing the line carbon emission factor and the transformer carbon intensity factor under the bus. In a possible application scenario, the present disclosure may calculate the respective carbon intensity factors of a transmission line and a transformer by topological fusion. Firstly, the terminal achieves the topological fusion in the power grid based on a topological relationship. The topological fusion includes fusion of power grid spatial data such as a topological structure of contents of a power generation network, a power transmission network, a power distribution network and a power consumption network and a connection relationship therebetween, a physical connection between the user and the power grid, and specific deployment positions of various sensors and data acquisition devices in the power grid. For example, the power generator set has a power supply path from an outlet of the power generator set to a 500 kV transformer. According to Kirchhoff's law, the carbon intensities of an alternating current line and a transformer on the power supply path are the same as that of the power plant. In the case that M power generator sets are present in a calculation range, M power supply paths are present. The terminal performs a cumulative summation on all substations and alternating current lines on the power supply path.

The following is a practical example illustrating the acquisition method of the bus carbon intensity. Assuming that the carbon intensity of the Gen-i^{th} power generator set in the power grid within the temporal and spatial statistical range is CIi, and the range involves j alternating current lines and m transformers, wherein the serial numbers of the alternating current lines are respectively Line-1, Line-2, . . . and Line-j, the serial numbers of the transformers are respectively Trans-1, Trans-2, . . . and Trans-m, then the carbon intensities of Line-1, Line-2, . . . and Line-j are all CIi and the carbon intensities of Trans-1, Trans-2, . . . and Trans-m are all CIi.

The statistics of the above statistical mode for one power generator set may be carried out subsequently by traversing all the power generator sets in the power grid within the temporal and spatial statistical range, thereby acquiring the carbon intensity of each power generator set on each power supply path and transformer. Finally, the carbon intensities of all the power supply paths and the carbon intensities of all the transformers are summed to acquire the total carbon intensity of all the power supply paths and all the transformers.

In step (3), the carbon intensities of the power generator sets in the target power generator set group are accumulated, and the acquired sum is added to the bus carbon intensity to acquire the carbon intensity in the temporal and spatial statistical range.

It should be noted that the bus carbon intensity represents the carbon intensity of the equivalent load. Therefore, for the carbon intensity of the power grid corresponding to the temporal and spatial statistical range, the carbon intensities of the power generator sets in the target power generator set group and the bus carbon intensity may be accumulated.

The bus carbon intensity is defined to indicate the bus carbon intensity corresponding to all equivalent loads in the temporal and spatial statistical range.

It should be noted that the present disclosure may also adjust the carbon intensity of a measured object by steps (a) and (b). The measured object may be a body such as a power generator set, a power plant, a regional power grid, a company or the like, which is not defined in the present disclosure. In the present disclosure, the carbon intensity of a power generator set may be acquired, and therefore the carbon intensity of a power plant, a regional power grid or a company may also be acquired by statistical collection.

In step (a), the number of green certificates of the measured object is acquired from a carbon exchange institute.

It should be noted that, to ensure the referentiality of system data, the present disclosure may verify the green certificated when acquiring the number of green certificates of the measured object in the carbon exchange institute. Optionally, a verification method includes encryption and verification with the carbon exchange. Alternatively, on the premise that the green certificate is made based on block chains, the verification may be performed by block chain verification.

In step (b), the carbon intensity factor of the measured object is adjusted according to a preset factor adjustment rule.

In this example, in the case that the carbon intensity factor of the measured object is A, and the measured object purchases the green certificate elsewhere, the carbon intensity factor of the measured object changes to B, which is less than A.

In the case that the carbon intensity factor of the original measured object is A, and the measured object purchases the green certificate elsewhere, the carbon intensity factor of the measured object changes to C, which is greater than A.

The factor adjustment rule is for regulating the relationship between the number of green certificates and the adjustment range of the carbon intensity factor. In one possible implementation, the factor adjustment rule indicates a linear relationship between the number of green certificates and the adjustment range of the carbon intensity factor.

In another possible implementation, the factor adjustment rule indicates a non-linear relationship between the number of green certificates and the adjustment range of the carbon intensity factor. In this scenario, in the case that the carbon intensity factor A of the measured object is greater than a first threshold, the ratio of the number of green certificates to the adjustment amount of the carbon intensity factor is P1. In the case that the carbon intensity factor A of the measured object is less than or equal to the first threshold and greater than a second threshold, the ratio of the number of green certificates to the adjustment amount of the carbon intensity factor is P2. In the case that the carbon intensity factor A of the measured object is less than or equal to the second threshold, the ratio of the number of green certificates to the adjustment amount of the carbon intensity factor is P3. Among these, the first threshold is greater than the second threshold, and P1>P2>P3.

It should be noted that in the case that the carbon intensity factor of the measured object is higher, the number of green certificates required to reduce a unit carbon intensity factor is greater; and in the case that the carbon intensity factor of the measured object is lower, the number of green certificates required to reduce the unit carbon intensity factor is smaller. Therefore, the measured object may be encouraged to pay attention to maintaining positivity of keeping a reasonable carbon intensity factor at all times.

Optionally, the terminal may use a genetic algorithm to mine frequent factors to form a carbon intensity factor correction library, which may be used to adjust the carbon intensity factor of the measured object together with the above factor adjustment rule.

It should be noted that, based on the statistical method of the carbon intensity provided by the present disclosure, the terminal may draw carbon footprints conveniently. The carbon footprint display may be a display of graphical components including task flow nodes and connecting lines. In a graphical display, the terminal may also display configuration information by attaching the configuration information to the corresponding object. The configuration information includes process node participant configuration, task process variable and task process condition configuration. During the result statistics, the carbon intensity is displayed on a map of the power grid by time, region and business, and finally a statistical analysis report is generated to provide decision information for professionals and facilitate refined and efficient management of carbon emission.

In summary, the embodiment may calculate the carbon intensity of the power generator set according to data provided by the power grid, and may freely switch between the spatial dimension and the temporal dimension in term of statistical dimension. The statistical data is real-time data according to the power grid where the power generator set is located. As such, the data has objectivity and timeliness, and may provide data convenience for further carbon emission trading and carbon emission labeling required for product manufacturing.

The method for calculating the carbon intensities according to this embodiment may also enable a user to more intuitively know the flow of the carbon intensity from a carbon footprint diagram.

The method for calculating the carbon intensities according to this embodiment may also consider the case that the grid has external input of electric energy, and calculate the carbon intensity of the electric energy at the same time, thereby ensuring that correct carbon emission data is provided in terms of each granularity in the power grid.

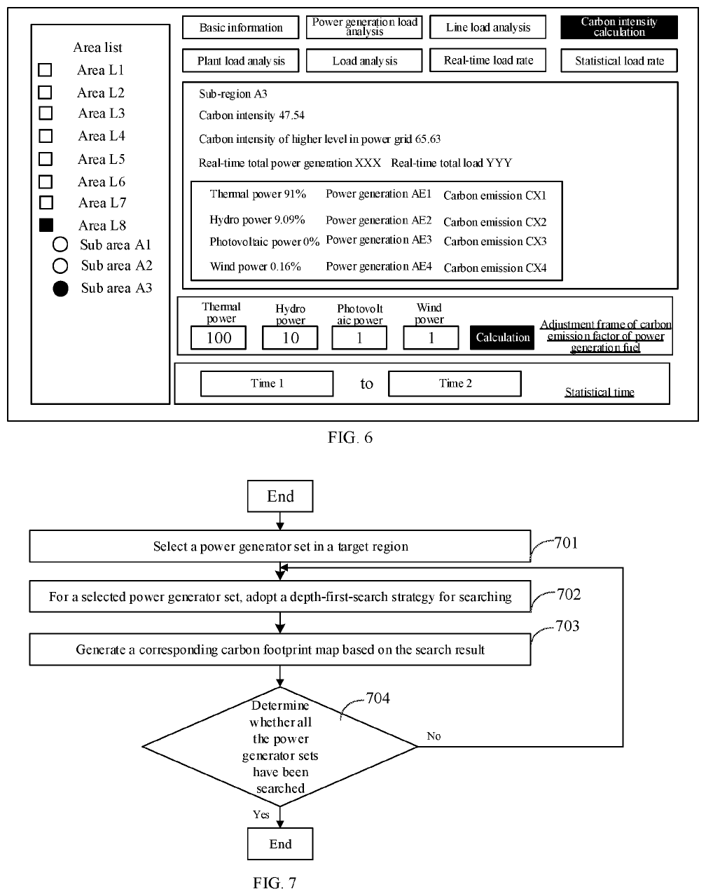

Now referring to FIG. 7, FIG. 7 is a flowchart of a method for tracking carbon footprints in a region according to an exemplary embodiment of the present disclosure. The solution shown in FIG. 7 is applicable to the terminal shown in FIG. 1. In FIG. 7, the method for tracking carbon footprints in the region may include the following steps.

In step 701, a power generator set in a target region is selected.

In this example, the target region may be an administrative region, or a business region divided according to subordination of a power plant, which is not defined in the embodiments of the present disclosure. The administrative region may be a country, a province, a city, a county, a district, or a town. The business region may be divided according to distribution of power plants, and the business region has no specific standard and is not exemplified herein.

In this example, the terminal may automatically determine the power generator set belonging to the target region after the user selects the target region. It should be noted that, in one possible example, the power generator set is a power generator set arranged in the target region. In another possible example, the power generator set is a power generator set belonging to the target region. Any one of the standards may be adopted in the present disclosure, which is not defined herein.

In step 702, for a selected power generator set, a depth-first-search strategy is adopted for searching.

In this example, for the selected power generator set in the target region, the terminal adopts the depth first strategy for searching, thereby acquiring a flow of the carbon intensity after the power generator set generates power. In other words, the step may determine a footprint corresponding to the carbon intensity generated by the selected power generator set.

In step 703, a corresponding carbon footprint map is generated based on the search result.

In this example, the terminal may generate the corresponding carbon footprint map based on the footprint corresponding to the carbon intensity generated by a single power generator set. It should be noted that, in this embodiment, due to the carbon footprint map to be drawn in the target region, each time a power generator set is processed, the carbon footprint map may be continuously drawn on the carbon footprint map acquired from the previous power generator set. The carbon footprint map is a superimposition outcome of footprints of the carbon intensities generated by the power generator sets.

In step 704, whether all the power generator sets have been searched is determined.

After searching all the power generator sets, the terminal ends the process and generates the carbon footprint map of the region. Upon completion of the searching, the process skips to step 702 and the subsequent steps are continuously performed until all the power generator sets are searched.

In summary, in the method for tracking carbon footprints in the region according to the embodiments of the present disclosure, a traverse statistical collection is performed on the power generator sets in the target region after the user selects the target region to be counted, and an overall carbon footprint map in the target region is generated after the carbon footprints generated by the power generator sets are processed one by one, thereby improving the efficiency of acquiring the carbon footprint map in the target region.

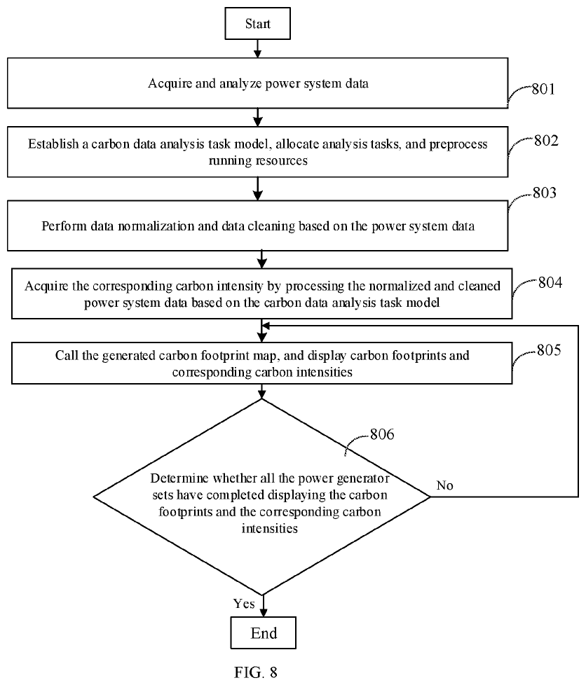

Now referring to FIG. 8, FIG. 8 is a flowchart of a method for calculating carbon intensities according to an exemplary embodiment of the present disclosure. The solution shown in FIG. 8 is applicable to the terminal shown in FIG. 1. In FIG. 8, the method for calculating the carbon intensities may include the following steps.

In step 801, power system data is acquired and analyzed.

In step 802, a carbon data analysis task model is established, analysis tasks are allocated, and running resources are preprocessed.

In step 803, data normalization and data cleaning are performed based on the power system data.

In step 804, the corresponding carbon intensity is acquired by processing the normalized and cleaned power system data based on the carbon data analysis task model.

In step 805, the generated carbon footprint map is called, and carbon footprints and corresponding carbon intensities are displayed.

In step 806, whether all the power generator sets have completed displaying the carbon footprints and the corresponding carbon intensities is determined.

In the case that all the power generator sets have completed displaying the carbon footprints and the corresponding carbon intensities, the terminal ends the process. In the case that there are power generator sets that have not completed displaying the carbon footprints and the corresponding carbon intensities, the method skips to step 805 and the subsequent step is continuously performed until all the power generator sets have completed displaying the carbon footprints and the corresponding carbon intensities.

In summary, in the embodiments of the present disclosure, the terminal automatically cleans and normalizes the power system data upon acquiring the data. After the carbon data analysis task model is established in advance, computing resources are preprocessed according to the model, and then the normalized power system data is introduced into the model for calculation, and upon processing of all the data, the corresponding carbon intensity data may be displayed together with the carbon footprints, such that the carbon footprints are displayed together with the combined carbon intensity data, which helps a user to understand the quantified indicators of the measured object in the field of environmental protection from the above two dimensions.

Now referring to FIG. 9, FIG. 9 is a flowchart of a method for calculating carbon intensities by region according to an exemplary embodiment of the present disclosure. The solution shown in FIG. 9 is applicable to the terminal shown in FIG. 1. In FIG. 9, the method for calculating the carbon intensities by region may include the following steps.

In step 901, an organization chart of power generator sets in a target region is read.

In step 902, actual power generation of hydro power generator sets, thermal power generator sets, wind power generator sets, photovoltaic power generator sets, nuclear power generator sets and biological energy storage power generator sets in a target region is read.

In step 903, a power load of the target region is read.

In step 904, the carbon intensity of the target region is calculated.

In step 905, the carbon intensity of each sub-region in the target region is summarized and accumulated.

In step 906, whether there are sub-regions that are not summarized is determined.

In the case that there is no sub-region that is not summarized, the process is ended. In the case that there is the sub-region that is not summarized, the process skips to step 902 and the subsequent steps are continuously performed for summarization until all the sub-regions are completely summarized to acquire the carbon intensity of the target region.

In summary, according to the embodiments of the present disclosure, statistical collection may be achieved for the carbon intensity according to different regions, and after the carbon intensities of all sub-regions in a target region are summarized, the total carbon intensity of the target region is acquired by summarization, thereby achieving the simultaneous acquisition of the carbon intensities at two statistical levels of the sub-region and the target region and improving topological property of the statistical data.

Described hereinafter is an embodiment of an apparatus that may be configured to perform the method according to the embodiments of the present disclosure. For details that are not disclosed in the apparatus embodiment of the present disclosure, reference may be made to the method embodiments of the present disclosure.

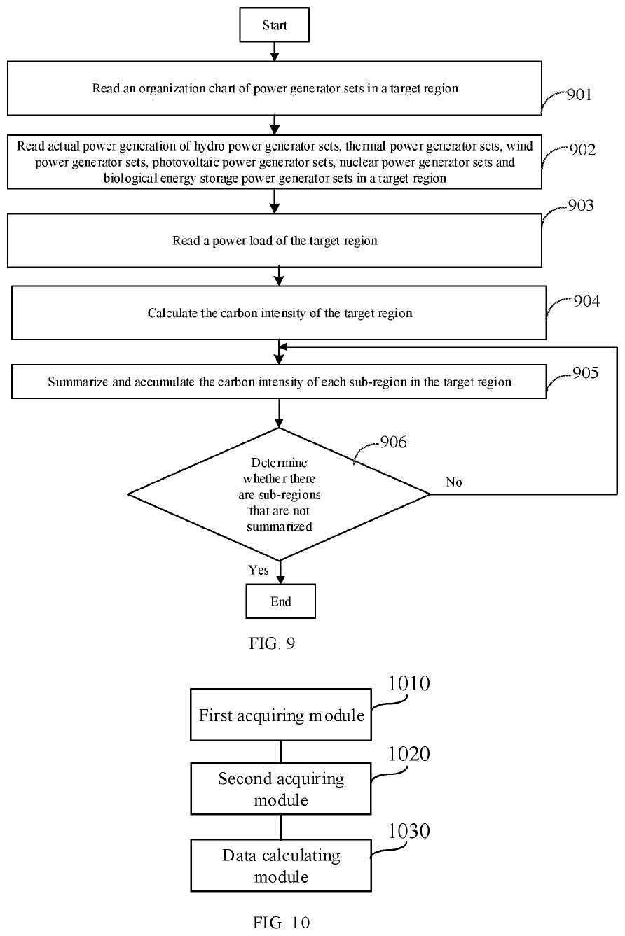

Now referring to FIG. 10, FIG. 10 is a structural block diagram of an apparatus for calculating carbon intensities according to an exemplary embodiment of the present disclosure. The apparatus for calculating the carbon intensities may be implemented as all or a part of a terminal by a software, a hardware, or a combination of the two. The apparatus includes:
a first acquiring module 1010, configured to acquire basic attribute data of a power system, and acquire an active power generation amount of a power generator set based on the basic attribute data;
a second acquiring module 1020, configured to acquire an initial value of a carbon emission factor of power generation fuel of the power generator set according to a life cycle type of the power generator set, wherein the initial value of the carbon emission factor of power generation fuel is defined to indicate a carbon emission amount caused by a unit power generation amount; and
a data calculating module 1030, configured to calculate a carbon intensity of the power generator set based on the active power generation and the initial value of the carbon emission factor of power generation fuel of the power generator set.

In an optional embodiment, the apparatus further includes a first executing module, configured to: acquire a load of the power generator set, and acquire a quotient by dividing the load of the power generator set by the carbon intensity of the power generator set, wherein the acquired quotient is a carbon intensity factor of the power generator set, and the carbon intensity factor is defined to indicate the carbon emission amount caused by the unit power generation amount of the power generator set, and is positively correlated with the initial value of the carbon emission factor of power generation fuel.

In an optional embodiment, the second acquiring module 1020 is configured to: in the case that the life cycle type is false, determine an intermediate carbon emission factor of power generation fuel corresponding to the type of the power generator set using a first preset mapping relationship; and determine the intermediate carbon emission factor of power generation fuel as the initial value of the carbon emission factor of power generation fuel corresponding to the type of the power generator set. Alternatively, the second acquiring module 1020 is configured to: in the case that the life cycle type is true, acquire a basic carbon emission factor of power generation fuel of the power generator set, wherein the basic carbon emission factor of power generation fuel is defined to indicate an estimate of a carbon emission amount generated by the power generator set before operation in generating power; determine the intermediate carbon emission factor of power generation fuel corresponding to the type of the power generator set using the first preset mapping relationship; and determine a sum of the intermediate carbon emission factor of power generation fuel and the basic carbon emission factor of power generation fuel as the initial value of the carbon emission factor of power generation fuel corresponding to the type of the power generator set.

In an optional embodiment, the second acquiring module 1020 is configured to: acquire the type of the power generator set, wherein the type of the power generator set is defined to indicate the input power adopted by the power generator set, and the input power includes at least one of thermal energy, hydro potential energy, wind kinetic energy, solar energy and nuclear energy; and determine the intermediate carbon emission factor of power generation fuel corresponding to the type of the power generator set according to a record of the first preset mapping relationship.

In an optional embodiment, the second acquiring module 1020 is configured to: in the case that the input energy adopted by the power generator set includes thermal energy and the power generator set is a thermal power generator set, determine a set of the intermediate carbon emission factors of power generation fuel corresponding to the thermal power generator set according to the record of the first preset mapping relationship, wherein the set of the intermediate carbon emission factors of power generation fuel is a set including n integers, n being a positive integer; acquire a thermal power carbon emission rating in the power system to which the thermal power generator set belongs, wherein the thermal power carbon emission rating is defined to indicate the carbon emission when the thermal power generator set generates a unit power; and determine the intermediate carbon emission factor of power generation fuel corresponding to the thermal power carbon emission rating from the set of the intermediate carbon emission factors of power generation fuel according to a second preset mapping relationship, wherein the second preset mapping relationship is associated with the power system to which the thermal power generator set belongs.

In an optional embodiment, the apparatus further includes a second executing module, configured to: acquire a temporal and spatial statistical range, wherein the temporal and spatial statistical condition includes a temporal range and/or a spatial range; determine the power generator set belonging to the temporal and spatial statistical range as a target power generator set group; and accumulate the carbon intensities of the power generator sets in the target power generator set group to acquire the carbon intensity corresponding to the temporal and spatial statistical range.

In an optional embodiment, the second executing module is configured to: acquire an equivalent load in the temporal and spatial statistical range, wherein the equivalent load is defined to indicate an external device powering the target power generator set group; acquire a bus carbon intensity on a power supply path of the equivalent load, wherein the bus carbon intensity is defined to indicate a sum of the carbon intensity of each line included in the bus and the carbon intensity of a transformer; and accumulate the carbon intensities of the power generator sets in the target power generator set group, and add the acquired sum to the bus carbon intensity to acquire the carbon intensity of the temporal and spatial statistical range.

In summary, according to the embodiments, the carbon intensity of the power generator set may be calculated according to data provided by the power grid, and the statistical collection may be freely switched between the spatial dimension and the temporal dimension. The statistical data is real-time data of the power grid where the power generator set is located. As such, the data is objective and timely, and thus data convenience may be provided for further carbon emission trading and carbon emission labeling required for product manufacturing.

The method for calculating the carbon intensities according to the embodiments may also enable a user to more intuitively know the flow of the carbon intensity from a carbon footprint diagram.

The method for calculating the carbon intensities according to the embodiments may also consider the case that the grid has external input of electric energy, and calculate the carbon intensity of the electric energy at the same time, thereby ensuring that correct carbon emission data is provided in terms of each granularity in the power grid.

An embodiment of the present disclosure further provides a non-transitory computer-readable medium storing one or more instructions thereon, wherein the one or more instructions, when loaded and executed by a processor of a terminal, causes the terminal to perform the method for calculating the carbon intensities according to the above embodiments.

It should be noted that: in the case that the apparatus for calculating the carbon intensities according to the above embodiments performs the method for calculating the carbon intensities, the division of the functional modules is merely exemplary. In practice, the above functions may be assigned to different functional modules according to needs, that is, the internal structure of the apparatus may be divided into different functional modules, so as to implement all or a part of the above functions. In addition, the apparatus for calculating the carbon intensities and the method for calculating the carbon intensities according to the above embodiments belong to the same inventive concept, and specific implementation processes thereof are described in the method embodiments in detail, which are thus not repeated herein.

The above serial numbers of the embodiments of the present disclosure are merely for description, and do not represent the advantages and disadvantages of the embodiments.

It may be appreciated by those of ordinary skill in the art that all or a part of the steps for implementing the above embodiments may be completed by hardware, or may be completed by instructing relevant hardware by a program stored in a computer-readable storage medium. The storage medium mentioned above may be a read-only memory, a magnetic disk, an optical disk, or the like.

Described above are merely exemplary embodiments of what may be implemented by the present disclosure and are not intended to limit the present disclosure. Any modifications, equivalents, improvements, and the like, made within the spirit and principle of the present disclosure should fall within the protection scope of the present disclosure.

What is claimed is:

1. A method for calculating carbon intensities, comprising:
acquiring basic attribute data of a power system, and acquiring an active power generation amount of a power generator set based on the basic attribute data;
acquiring an initial value of a carbon emission factor of power generation fuel of the power generator set according to a life cycle type of the power generator set, wherein the initial value of the carbon emission factor of power generation fuel is defined to indicate a carbon emission amount caused by a unit power generation amount; and
calculating a carbon intensity of the power generator set based on the active power generation amount and the initial value of the carbon emission factor of power generation fuel of the power generator set.

2. The method according to claim 1, wherein upon calculating the carbon intensity of the power generator set, the method further comprises:
acquiring a load of the power generator set;
acquiring an quotient by dividing the load of the power generator set by the carbon intensity of the power generator set, wherein the acquired quotient is a carbon intensity factor of the power generator set, and the carbon intensity factor is defined to indicate the carbon emission amount caused by the unit power generation amount of the power generator set, and is positively correlated with the initial value of the carbon emission factor of power generation fuel.

3. The method according to claim 2, wherein acquiring the initial value of the carbon emission factor of power generation fuel of the power generator set according to the life cycle type of the power generator set comprises:
in the case that the life cycle type is false, determining an intermediate carbon emission factor of power generation fuel corresponding to the type of the power generator set using a first preset mapping relationship; and
determining the intermediate carbon emission factor of power generation fuel as the initial value of the carbon emission factor of power generation fuel corresponding to the type of the power generator set; or
in the case that the life cycle type is true, acquiring a basic carbon emission factor of power generation fuel of the power generator set, wherein the basic carbon emission factor of power generation fuel is defined to indicate an estimate of a carbon emission amount generated by the power generator set before operation in generating power;
determining the intermediate carbon emission factor of power generation fuel corresponding to the type of the power generator set using the first preset mapping relationship; and
determining a sum of the intermediate carbon emission factor of power generation fuel and the basic carbon emission factor of power generation fuel as the initial value of the carbon emission factor of power generation fuel corresponding to the type of the power generator set.

4. The method according to claim 3, wherein determining the intermediate carbon emission factor of power generation fuel corresponding to the type of the power generator set using the first preset mapping relationship comprises:
acquiring the type of the power generator set, wherein the type of the power generator set is defined to indicate the input power adopted by the power generator set, and the input power comprises at least one of thermal energy, hydro potential energy, wind kinetic energy, solar energy and nuclear energy; and
determining the intermediate carbon emission factor of power generation fuel corresponding to the type of the power generator set according to a record of the first preset mapping relationship.

5. The method according to claim 4, wherein in the case that the input energy adopted by the power generator set comprises thermal energy, the power generator set is the thermal power generator set, and determining the intermediate carbon emission factor of power generation fuel corresponding to the type of the power generator set according to the record of the first preset mapping relationship comprises:
determining a set of the intermediate carbon emission factors of power generation fuel corresponding to the thermal power generator set according to the record of the first preset mapping relationship, wherein the set of the intermediate carbon emission factors of power generation fuel is a set comprising n integers, n being a positive integer;
acquiring a thermal power carbon emission rating in the power system to which the thermal power generator set belongs, wherein the thermal power carbon emission rating is defined to indicate the carbon emission amount when the thermal power generator set generates a unit power; and
determining the intermediate carbon emission factor of power generation fuel corresponding to the thermal power carbon emission rating from the set of the intermediate carbon emission factors of power generation fuel according to a second preset mapping relationship, wherein the second preset mapping relationship is associated with the power system to which the thermal power generator set belongs.

6. The method according to any one of claims 1 to 5, further comprising:
acquiring a temporal and spatial statistical range, wherein the temporal and spatial condition comprises a temporal range and/or a spatial range;
determining the power generator set belonging to the temporal and spatial statistical range as a target power generator set group; and
acquiring the carbon intensity corresponding to the temporal and spatial statistical range by accumulating the carbon intensities of the power generator sets in the target power generator set group.

7. The method according to claim 6, wherein accumulating the carbon intensities of the power generator sets in the target power generator set group to acquire the carbon intensity of the temporal and spatial statistical range comprises:
acquiring an equivalent load in the temporal and spatial statistical range, wherein the equivalent load is defined to indicate an external device powering the target power generator set group;
acquiring a bus carbon intensity on a power supply path of the equivalent load, wherein the bus carbon intensity is defined to indicate a sum of the carbon intensity of each line included in the bus and the carbon intensity of a transformer; and
acquiring the carbon intensity of the temporal and spatial statistical range by accumulating the carbon intensities of the power generator sets in the target power generator set group and adding the acquired sum to the bus carbon intensity.

8. An apparatus for calculating carbon intensities, comprising:
a first acquiring module, configured to acquire basic attribute data of a power system, and acquire an active power generation amount of a power generator set based on the basic attribute data;
a second acquiring module, configured to acquire an initial value of a carbon emission factor of power generation fuel of the power generator set according to a life cycle type of the power generator set, wherein the initial value of the carbon emission factor of power generation fuel is defined to indicate a carbon emission amount caused by a unit power generation amount; and
a data calculating module, configured to calculate a carbon intensity of the power generator set based on the active power generation amount and the initial value of the carbon emission factor of power generation fuel of the power generator set.

9. A terminal, comprising: a processor, a memory communicably connected to the processor, and one or more program instructions stored on the memory, wherein the processor, when loading and executing the one or more program instructions, is caused to perform the method for calculating the carbon intensities as defined in any one of claims 1 to 7.

10. A non-transitory computer-readable storage medium storing one or more program instructions thereon, wherein the one or more program instructions, when loaded and executed by a processor of a terminal, causes the terminal to perform the method for calculating the carbon intensities as defined in any one of claims 1 to 7.
